(19) United States
(12) Patent Application Publication
(10) Pub. No.: US 2003/0188209 A1
(43) Pub. Date: Oct. 2, 2003

(54) Control circuit, electronic circuit, and method of saving power

(76) Inventor: Yuusuke Nosaka, Ome-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/394,210

(22) Filed: Mar. 24, 2003

(30) Foreign Application Priority Data
Mar. 25, 2002 (JP) 2002-084324

(51) Int. Cl. G06F 1/32

(52) U.S. Cl. 713/320

(57) ABSTRACT

There is provided an electronic circuit capable of operating in a normal-operating mode and a power-saving mode. The electronic circuit includes a buffer cell having a buffer and an active pull-up unit, and a control circuit configured to invalidate the active pull-up unit and an input signal to the buffer when the electronic circuit has been switched to the power-saving mode.

### CROSS-REFERENCE TO RELATED APPLICATIONS

This application is based upon and claims the benefit of priority from the prior Japanese Patent Application No. 2002-084324, filed Mar. 25, 2002, the entire contents of which are incorporated herein by reference.

### BACKGROUND OF THE INVENTION

1. Field of the Invention

The present invention relates to a control circuit for controlling a buffer cell having an active pull-up function, an electronic circuit, and a method of saving power.

2. Description of the Related Art

Hitherto, various electronic apparatuses incorporate an LSI that includes input/output (I/O) buffer cells (also known as “pull-up pins” or “I/O pins”) that has a pull-up function. The LSI may be, for example, one that incorporates a card controller designed to control a specific card. In an LSI of this type, the I/O buffer cell is provided in the card controller and is configured to input a signal on a signal line provided to detect a card removably coupled to the electronic apparatus.

Among I/O buffer cells that have a pull-up function is a cell called “active pull-up pin.” The active pull-up pin is an I/O buffer cell whose pull-up function can be validated and invalidated. An I/O buffer cell can perform an active pull-up function.

In the I/O buffer cell, an I/O buffer is connected to an input terminal and an output terminal of the I/O buffer cell. A pull-up resistor and a switch are connected in series, between the input terminal and a power supply. The switch can be turned on and off.

Assume that the active pull-up pin is used (that is, the switch is turned on) while the electronic apparatus remains in suspend mode. Then, a current will leak from the input terminal through the pull-up resistor if the signal at the input terminal stays at ground level. In this case, the power is wasted in vain.

### BRIEF SUMMARY OF THE INVENTION

Embodiments of the present invention provide a control circuit, an electronic circuit, and a method of saving power, which are capable of decreasing unnecessary power consumption in a buffer cell having an active pull-up function while the buffer cell remains in power-saving mode.

According to an aspect of the present invention, there is provided a method of saving power in an electronic apparatus that includes a buffer cell having a buffer and an active pull-up unit, the method comprising determining whether or not the electronic apparatus has been switched to a power-saving mode; and invalidating the active pull-up unit and an input signal to the buffer when the determination indicates that the electronic apparatus has been switched to the power-saving mode.

According to another aspect of the present invention, there is provided an electronic circuit capable of operating in a normal-operating mode and a power-saving mode, comprising a buffer cell having a buffer and an active pull-up unit; and a control circuit configured to invalidate the active pull-up unit and an input signal to the buffer when the electronic circuit has been switched to the power-saving mode.

According to still another aspect of the present invention, there is provided a control circuit which is provided in an electronic apparatus capable of operating in a normal-operating mode and a power-saving mode, and which is configured to control a buffer cell having a buffer and an active pull-up unit, the control circuit comprising a detector configured to detect that the electronic apparatus has been switched to the power-saving mode; and a controller configured to invalidate the active pull-up unit and an input signal to the buffer when the detector detects that the electronic apparatus has been switched to the power-saving mode.

Additional embodiments and advantages of the invention will be set forth in the description which follows, and in part will be obvious from the description, or may be learned by practice of the invention. The embodiments and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram of an electronic apparatus including I/O buffer cells and control circuits according to an embodiment of the present invention;

FIG. 2 is a block diagram illustrating an internal structure that the LSI shown in FIG. 1 may have;

FIG. 3 is a circuit diagram showing an internal structure that each I/O buffer cell shown in FIG. 2 may have;

FIG. 4 is a table for explaining how the control circuit operates while the electronic apparatus remains in normal-operating mode and the suspend mode;

FIG. 5 is a block diagram illustrating another internal structure that the LSI shown in FIG. 2 may have;

FIG. 6 is a diagram for explaining a technique of informing that the electronic apparatus has been switched to the suspend mode by using software; and

FIG. 7 is a flowchart explaining an operation in the embodiment of the present invention.

### DETAILED DESCRIPTION OF THE INVENTION

Embodiments of the present invention will be described below with reference to the drawings.

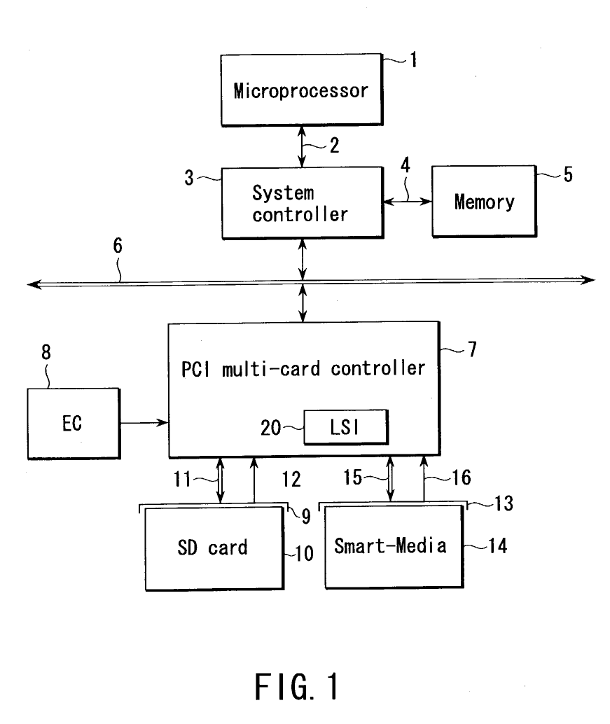

FIG. 1 is a block diagram of an electronic apparatus including I/O buffer cells and control circuits according to an embodiment of the present invention.

The electronic apparatus may be, for example, a personal computer or a personal digital assistant (PDA). As FIG. 1 shows, the apparatus includes a microprocessor 1, a microprocessor bus 2, a system controller 3, a memory bus 4, a memory 5, a peripheral component interconnect bus (PCI) bus 6, a PCI multi-card controller 7, an embedded controller (EC) 8, an SD™ (Secure Digital) card holder 9, an SD card™ 10, an SD-card™ bus 11, an SD-card™ detection signal line 12, a Smart-Media™ holder 13, a Smart-Media™ 14, a bus 15, a detection signal line 16, and an LSI 20.

The microprocessor 1 controls the entire operations of the electronic apparatus and executes commands and the like received from various software items.

The microprocessor bus 2 is a bus that connects the microprocessor 1 and the system controller 3. The microprocessor bus 2 is configured to transfer commands from the microprocessor 1 to the system controller 3.

The system controller 3 is connected to the memory 5 and PCI bus 6, as well as to the microprocessor 1. The controller 3 executes arbitration with respect to such devices and executes transactions.

The memory bus 4 is a bus that connects the system controller 3 and the memory 5. The memory bus 4 is configured to transfer data when the microprocessor 1 accesses the memory 5.

The memory 5 stores the OS, various application programs and various drivers (including those for the SD card™ 10 and Smart-Media™ 14). The memory 5 is used as work area of the microprocessor 1.

The PCI bus 6 is configured to transfer data between the system controller 3 and a PCI device in accordance with PCI architecture.

The PCI multi-card controller 7 includes an LSI 20. The LSI 20 incorporates an SD-card™ controller and a Smart-Media™ controller (to be described later). The SD-card™ controller controls the SD card™ 10, and the Smart-Media™ controller controls the Smart-Media™ 14.

The embedded controller (EC) 8 manages the power-supply state of the electronic apparatus. When the operating mode of the electronic apparatus changes from the normal operating mode to the power-saving mode (e.g., suspend mode), the EC 8 generates a signal indicating this change of operating mode. The signal is supplied to the OS stored in the memory 5 and to the LSI 20 provided in the PCI multi-card controller 7.

The SD-card™ holder 9 is provided to hold an SD card™.

The SD card™ 10 may be an SD memory card or an SDIO card.

The SD-card™ bus 11 is configured to transfer data between the SD card™ 10 set in the electronic apparatus and the PCI multi-card controller 7.

The SD-card™ detection signal line 12 is used to supply a signal indicating whether the SD card™ 10 has been inserted into the electronic apparatus.

The Smart-Media™ holder 13 is provided to hold a Smart-Media™.

The Smart-Media™ 14 is a memory card that contains an NAND flash memory.

The bus 15 is a bus configured to transfer data between the Smart-Media™ 14 held in the electronic apparatus and the PCI multi-card controller 7. The detection signal line 16 is used to supply a signal indicating whether the Smart-Media™ 14 has been inserted into the electronic apparatus.

The LSI 20 is an electronic circuit (chip) that is incorporated in the PCI multi-card controller 7.

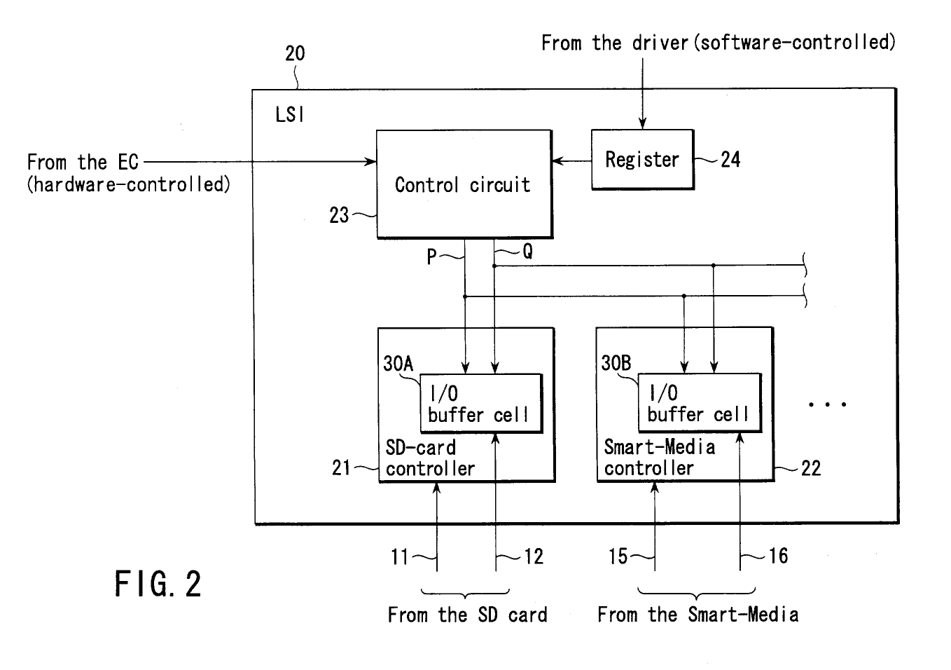

FIG. 2 is a block diagram depicting an internal structure that the LSI 20 (FIG. 1) may have. As seen from FIG. 2, the LSI 20 includes an SD-card™ controller 21, a Smart-Media™ controller 22, a control circuit 23, and a register 24. The SD-card™ controller 21 incorporates an I/O buffer cell 30A. The Smart-Media™ controller 22 incorporates an I/O buffer cell 30B. The I/O buffer cells 30A and 30B (also known as “pull-up pins” or “I/O pins”) are of the same type.

The SD-card™ bus 11 and SD-card™ detection signal line 12 electrically connect the SD-card™ controller 21 to the SD-card™ holder 9. The controller 21 can control the SD card™ held in the SD-card™ holder 9. The SD-card™ detection signal line 12 is electrically connected to an I/O buffer (to be described later) that is provided in the I/O buffer cell 30A.

The bus 15 and detection signal line 16 electrically connect the Smart-Media™ controller 22 to the Smart-Media™ holder 13. The controller 22 can control the Smart-Media™ held in the Smart-Media™ holder 13. The detection signal line 16 is electrically connected to an I/O buffer (to be described later) that is incorporated in the I/O buffer cell 30B.

The control circuit 23 can invalidate the active pull-up function of both I/O buffer cells 30A and 30B when the electronic apparatus is switched to the suspend mode. The control circuit 23 can invalidate input signals to the I/O buffers in the I/O buffer cells 30A and 30B, when the electronic apparatus is switched to the suspend mode.

The control circuit 23 can determine that the electronic apparatus has been switched to the suspend mode, from a signal from the EC 8 that is the hardware managing the power-supply state of the electronic apparatus. Alternatively, the circuit 23 can determine the mode switching from the data written in the register 24 by the software (a driver or an application program) provided to recognize the power-supply state of the electronic apparatus.

The resister 24 is used as a data storage, into which the driver or the like may write the data representing the power-supply state of the electronic apparatus and from which the control circuit 23 may read this data.

The I/O buffer cells 30A and 30B are active pull-up pins that perform an active pull-up function, i.e., turning on or off a pull-up function.

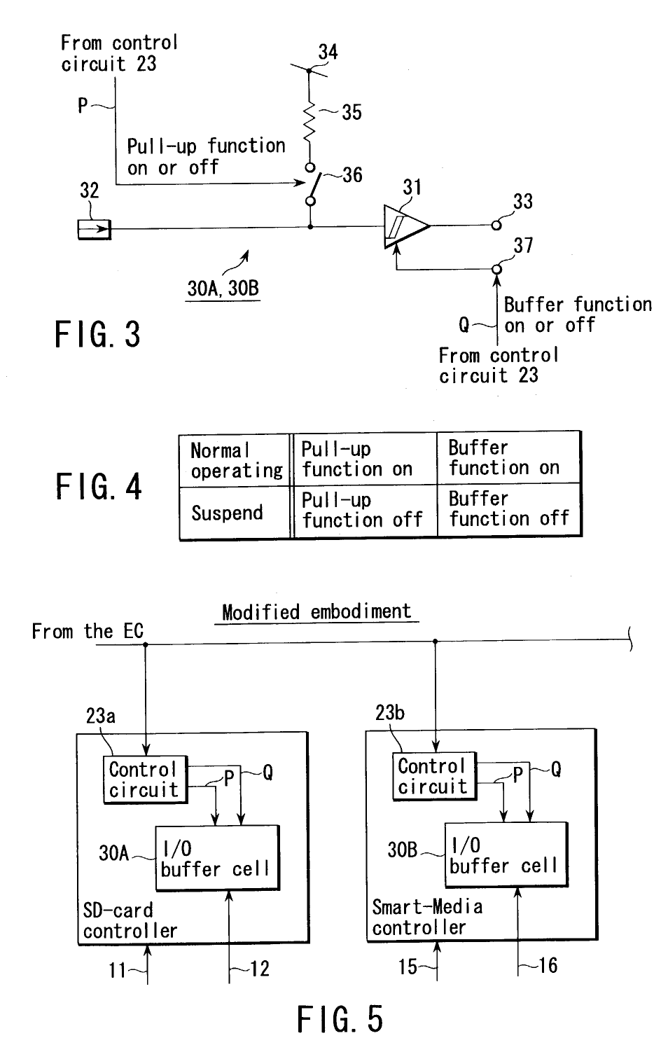

FIG. 3 is a block diagram showing an internal structure that each I/O buffer cells 30A and 30B shown in FIG. 2 may have.

As FIG. 3 depicts, each I/O buffer cell includes an I/O buffer 31, an input terminal 32, an output terminal 33, a power supply 34, a pull-up resistor 35, a switch 36, and a control terminal 37.

The I/O buffer 31 is provided on the signal line that connects the input terminal 32 to the output terminal 33. The I/O buffer 31 temporarily stores the data it has received. The signal line is active as long as the signal on it remains at the low level.

In the normal operating mode, the control signal Q supplied to the I/O buffer 31 via the control terminal 37 is at the high level. In this case, the I/O buffer 31 outputs a low-level signal if the input signal is at a low level, and outputs a high-level signal if the input signal is at a high level.

In the suspend mode, the control signal Q supplied to the I/O buffer 31 via the control terminal 37 is at the low level. In this case, the I/O buffer 31 outputs a high-level signal, regardless of the level of the signal it receives from the input terminal 32. That is, the I/O buffer 31 fixes the output signal at the high level in the suspend mode, whether the input signal is at the high level or the low level. Once the output signal is fixed at the high level, a through current (to be described later) does not flow in the I/O buffer 31.

The input terminal 32 is electrically connected to either the SD-card™ detection signal line 12 or the detection signal line 16. It supplies the input signal to the I/O buffer 31. (The input signal assumes one of two values that correspond to the high and low levels.)

The output terminal 33 receives the signal output from the I/O buffer 31 and supplies the signal to an external device. (The signal output from the terminal 33 is data that has one of two values corresponding to the high and low levels.)

The power supply 34 is provided within the LSI 20. It supplies a current to the pull-up resistor 35. The pull-up resistor 35 is connected to the power supply 34.

The switch 36 is provided between, and connected to, the pull-up resistor 35 and the input terminal of the I/O buffer 31. The switch 36 is turned on or off in accordance with a switching signal P supplied from the control circuit 23. (That is, the pull-up function is turned on or off.)

The control terminal 37 receives a control signal Q from the control circuit 23 and supplies the signal Q to the I/O buffer 31. The control signal Q switches the I/O buffer 31 from on state to off state, or vice versa.

Before an SD card™ or Smart-Media™ 14 is inserted into the electronic apparatus, a signal output from the I/O buffer 31 is set at a high level when a level of a signal input to the I/O buffer 31 is pulled up. When an SD card™ or Smart-Media™ 14 is inserted into the electronic apparatus, an input signal to the input terminal 32 is set at the ground level and an output signal is set at a low level. At this time, a current flows from the power supply 34 to the input terminal 32.

How the control circuit 23 operates while the electronic apparatus remains in the normal operating mode and the suspend mode will be explained, with reference to FIG. 4.

While the electronic apparatus remains in the normal operating mode, the control circuit 23 supplies the switching signal P to the switch 36, which is closed to turn on the pull-up function. Further, the control circuit 23 supplies the control signal Q (at high level) to the I/O buffer 31 via the control terminal 37, turning on the buffer function.

When the electronic apparatus is switched to the suspend mode, the control circuit 23 supplies the switching signal P to the switch 36, which is opened to turn off the pull-up function. In this case, the control circuit 23 supplies the control signal Q (at low level) to the I/O buffer 31 via the control terminal 37, turning off the buffer function. The control signal Q (at low level) fixes the signal output from the I/O buffer 31, at a predetermined level (i.e., high level), regardless of the level of the signal input to the I/O buffer 31.

That is, the switch 36 is turned off (to turn off the active pull-up function) when the electronic apparatus is switched to the suspend mode. This is because a current must be prevented from flowing from the power supply 34 to the input terminal 32. Now that when the switch 36 is off, no current leaks from the input terminal 32 through the pull-up resistor 35 even if the input terminal 32 remains at the ground level. This helps to decrease unnecessary power consumption in the electronic apparatus.

While the electronic apparatus remains in the suspend mode, the signal at the input terminal 32 may change from the ground level to an intermediate level (an unstable level, not low level or high level). For example, the user may remove an SD card™ from the SD-card™ holder 9, or may remove a Smart-Media™ from the Smart-Media™ holder 13 when the switch 36 is off. In this case, a signal of an unstable level is generated in either the SD-card™ detection signal line 12 or the detection signal line 16. This signal reaches the input terminal 32. In such a case, a through current will flow in the I/O buffer 31 if the switch 36 is off.

In the present embodiment, the function (i.e., function of outputting a signal whose level is equal to the level of an input signal) of the I/O buffer 31 is invalidated at the same time the active pull-up function is turned off. At this time, the output signal from the I/O buffer 31 is fixed at a high level. This makes it possible to decrease the power consumption in the electronic apparatus and to prevent a through current from flowing in the I/O buffer 31. This saves power and the power consumption in the LSI 20 can be reduced while the electronic apparatus remains in the suspend mode.

FIG. 5 is a block diagram illustrating another internal structure that the LSI shown in FIG. 2 may have.

In the structure of FIG. 2, the control circuit 23 is provided outside the SD card™ controller 21 and Smart-Media™ controller 22. Instead, two control circuits 23a and 23b may be incorporated in the card controllers 21 and 22, respectively, as is illustrated in FIG. 5. In the structure of FIG. 5, two registers that correspond to the register 24 shown in FIG. 2 may be provided in the card controllers 21 and 22, respectively.

As specified with reference to FIG. 2, the control circuit 23 determines whether the electronic apparatus has been switched to the suspend mode, by using either software or hardware.

When hardware is used, the EC 8 supplies a signal to the control circuit 23, said signal indicating that the electronic apparatus has been switched to the suspend mode. From this signal the control circuit 23 determines that the electronic apparatus has been switched to the suspend mode. In case of using such hardware, the load on the software can be reduced.

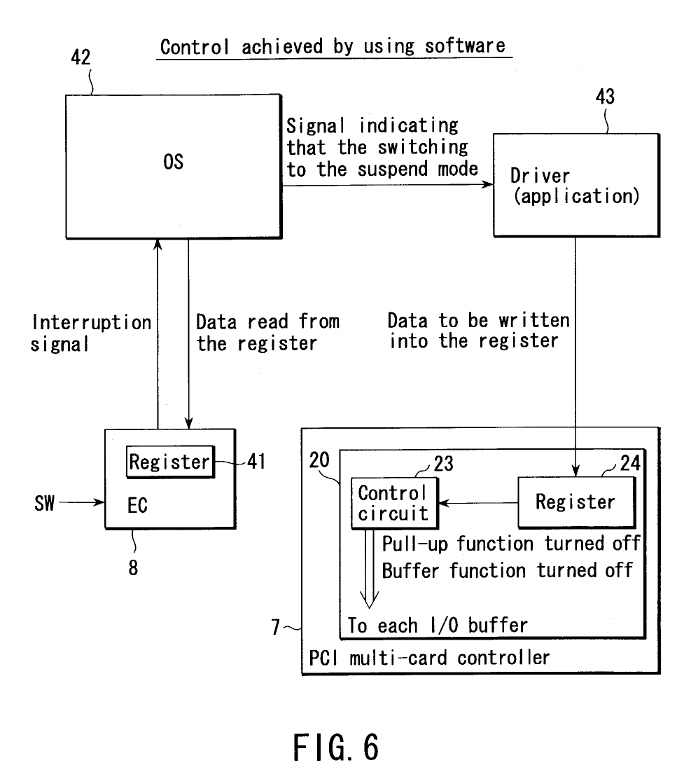

Next, a method using software will be described with reference to FIG. 6.

The EC 8 may detect that the electronic apparatus has been switched to the suspend mode as the user operates, for example, a switch. Upon detecting the switching of mode, the EC 8 writes into the register 41 the data representing the switching of mode. At the same time, the EC 8 sends an interruption signal to the OS 42. In response to the interruption signal, the OS 42 reads the data from the register 41. The data thus read and showing that the apparatus is now in the suspend mode is supplied to a driver (or an application program) 43. The driver 43 writes this data into the register 24 incorporated in the LSI 20. Thus, from the data read from the register 41 the control circuit 23 determines that the electronic apparatus has been switched to the suspend mode.

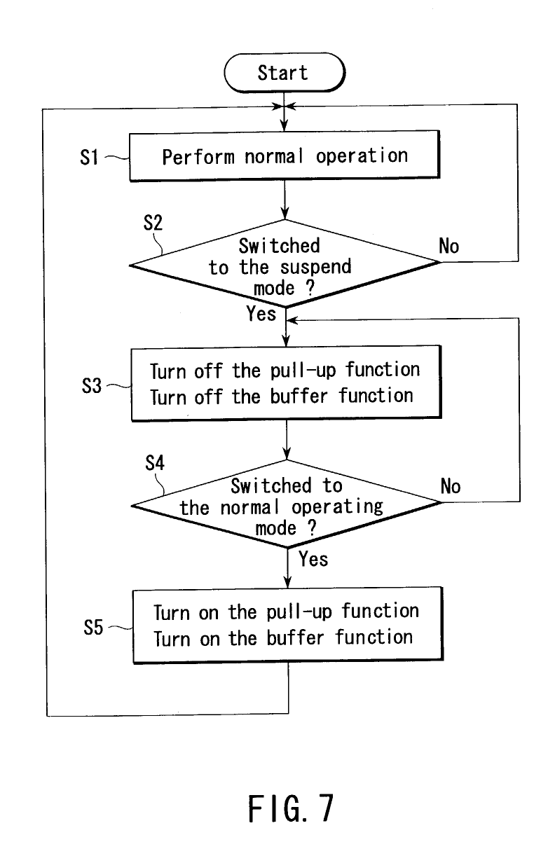

Now, an operation in the present embodiment will be described, with reference to the flowchart of FIG. 7.

Assume that the electronic apparatus is in the normal operating mode (Step S1). The control circuit 23 determines whether the electronic apparatus has been switched to the suspend mode (Step S2). If NO at Step S2, the apparatus keeps operating in the normal operating mode.

If YES at Step S2, that is, if the control circuit 23 determines that the apparatus has been switched to the suspend mode, it supplies a switching signal P to the switch 36. The switch 36 is opened, turning off the pull-up function. At the same time, the control circuit 23 supplies the control signal Q (at low level) to the I/O buffer 31 via the control terminal 37, turning off the buffer function (Step S3). The control signal Q fixes the signal output from the I/Q buffer 31, at a predetermined level (i.e., high level), regardless of the level of the signal input to the I/O buffer 31.

The control circuit 23 determines whether the electronic apparatus has been switched back to the normal operating mode (Step S4). If NO at Step S4, that is, if the apparatus has not been switched to the normal operating mode, both the pull-up function and the buffer function remain off.

If YES at Step S4, that is, if the apparatus has not been switched back to the normal operating mode, the control circuit 23 supplies a switching signal P to the switch 36, closing the switch 36. Thus closed, the switch 36 turns on the pull-up function. At the same time, the control circuit 23 supplies a control signal Q (at high level) to the I/O buffer 31 via the control terminal 37. The control signal Q sets the signal output from the I/O buffer 31, whereby the buffer function is turned on (Step S5). Thereafter, the operation returns to Step S1.

In the present embodiment, the switch 36 is opened to turn off the active pull-up function, while the electronic apparatus remains in the suspend mode, if the input terminal is at the ground level. This prevents a current from leaking from the input terminal 32 through the pull-up resistor 35. As a result, the power consumption can be reduced in the electronic apparatus.

In addition, an input signal to the I/O buffer 31 is invalidated at the same time the active pull-function is turned off in the present embodiment. Hence, no through currents flows in the I/O buffer 31 when the signal at the input terminal 32 changes from the ground level to an intermediate level (an unstable level, not low level or high level) while the electronic apparatus remains in the suspend mode. This saves power and the power consumption in the LSI 20 can be reduced while the electronic apparatus remains in the suspend mode.

The present invention is not limited to the embodiment described above. Various changes and modifications can be made, without departing from the scope and spirit of the invention. For example, the signal line on which the I/O buffer 31 is provided may be active when the signal on the line is at high level, not at low level as in the embodiment. In this case, the various signals are reversed in term of their levels.

As has been described in detail, according to the present invention, it is possible to decrease unnecessary power consumption in a buffer cell having an active pull-up function while the buffer cell remains in power-saving mode.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of saving power in an electronic apparatus that includes a buffer cell having a buffer and an active pull-up unit, said method comprising:
determining whether or not the electronic apparatus has been switched to a power-saving mode; and
invalidating the active pull-up unit and an input signal to the buffer when the determination indicates that the electronic apparatus has been switched to the power-saving mode.

2. The method according to claim 1, wherein the invalidating includes fixing an output signal from the buffer at a predetermined level.

3. The method according to claim 1, wherein the power-saving mode includes a suspend mode.

4. The method according to claim 1, wherein the invalidating includes supplying a switching signal to a switch, which is configured to turn on and off the active pull-up unit, to turn off the switch and a control signal to the buffer to maintain a signal output from the buffer at a specific level, regardless of a level of a signal input to the buffer, when the determination indicates that the electronic apparatus has been switched to the power-saving mode.

5. An electronic circuit capable of operating in a normal-operating mode and a power-saving mode, comprising:
a buffer cell having a buffer and an active pull-up unit; and
a control circuit configured to invalidate the active pull-up unit and an input signal to the buffer when the electronic circuit has been switched to the power-saving mode.

6. The electronic circuit according to claim 5, wherein the control circuit determines that the electronic circuit has been switched to the power-saving mode by receiving a signal from hardware which manages a power-supply state of the electronic circuit.

7. The electronic circuit according to claim 5, wherein the control circuit determines that the electronic circuit has been switched to the power-saving mode by referring to data written in a register using software that recognizes a power-supply state of the electronic circuit.

8. The electronic circuit according to claim 5, wherein the buffer has an input terminal that is connected to a signal line provided to detect a device which is removably coupled to an electronic apparatus.

9. The electronic circuit according to claim 5, wherein the power-saving mode includes a suspend mode.

10. The electronic circuit according to claim 5, wherein the control circuit supplies a switching signal to a switch, which is configured to turn on and off the active pull-up unit, to turn off the switch and a control signal to the buffer to maintain a signal output from the buffer at a specific level, regardless of a level of a signal input to the buffer, when the electronic circuit has been switched to the power-saving mode.

11. A control circuit which is provided in an electronic apparatus capable of operating in a normal-operating mode and a power-saving mode, and which is configured to control a buffer cell having a buffer and an active pull-up unit, the control circuit comprising:
a detector configured to detect that the electronic apparatus has been switched to the power-saving mode; and
a controller configured to invalidate the active pull-up unit and an input signal to the buffer when the detector detects that the electronic apparatus has been switched to the power-saving mode.

12. The control circuit according to claim 11, wherein the detector detects that the electronic apparatus has been switched to the power-saving mode by receiving a signal from hardware which controls a power-supply state of the electronic apparatus.

13. The control circuit according to claim 11, wherein the detector detects that the electronic apparatus has been switched to the power-saving mode by referring to data written in a register using software that recognizes a power-supply state of the electronic apparatus.

14. The control circuit according to claim 11, wherein the buffer has an input terminal that is connected to a signal line provided to detect a device which is removably coupled to the electronic apparatus.

15. The control circuit according to claim 11, wherein the power-saving mode includes a suspend mode.

16. The control circuit according to claim 11, wherein the controller supplies a switching signal to a switch, which is configured to turn on and off the active pull-up unit, to turn off the switch and a control signal to the buffer to maintain a signal output from the buffer at a specific level, regardless of a level of a signal input to the buffer, when the detector detects that the electronic apparatus has been switched to the power-saving mode.
